(19) United States
(12) Patent Application Publication
(10) Pub. No.: US 2025/0229602 A1
(43) Pub. Date: Jul. 17, 2025

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Yong Woong Cha, Hwaseong-si (KR); Seong-Bin Jeong, Hwaseong-si (KR); Dongseok Oh, Hwaseong-si (KR); Jungha Park, Hwaseong-si (KR)

(73) Assignees: HYUNDAI MOTOR COMPANY, Seoul (KR); KIA CORPORATION, Seoul (KR)

(21) Appl. No.: 18/816,506

(22) Filed: Aug. 27, 2024

(30) Foreign Application Priority Data
Jan. 15, 2024 (KR) 10-2024-0005949

(51) Int. Cl. B60H 1/00

(52) U.S. Cl. CPC B60H 1/00907

(57) ABSTRACT

A heat pump system for a vehicle is configured to selectively exchange heat between coolant and the thermal energy generated from refrigerant at the time of condensation and evaporation of the refrigerant. The heat pump system heats the vehicle interior using the heat-exchanged high-temperature coolant and improves the heating efficiency of the vehicle by selectively using the ambient air heat, the waste heat of electrical components, and the waste heat of the battery module, at the time of heating the vehicle interior, thereby increasing the overall travel distance of the vehicle by efficiently adjusting the temperature of a battery module for an optimal performance of the battery module.

### CROSS-REFERENCE TO RELATED APPLICATION

This application claims priority to and the benefit of Korean Patent Application No. 10-2024-0005949, filed on Jan. 15, 2024, the entire contents of which are incorporated herein by reference.

### BACKGROUND

### (a) Field

The present disclosure relates to a heat pump system for a vehicle. More particularly, the present disclosure relates to a heat pump system for a vehicle capable of improving heating performance.

### (b) Description of the Related Art

Generally, an air conditioning system for a vehicle includes an air conditioner unit circulating a refrigerant in order to heat or cool an interior of the vehicle.

The air conditioner unit, which is used to maintain the interior of the vehicle at an appropriate temperature regardless of a change in an external temperature, is configured to heat or cool the interior of the vehicle by heat-exchange using a condenser and an evaporator in a process in which a refrigerant discharged by driving a compressor is circulated back to the compressor through the condenser, a receiver drier, an expansion valve, and the evaporator.

In other words, the air conditioner unit lowers a temperature and humidity of the interior of the vehicle by condensing a high-temperature high-pressure gas-phase refrigerant compressed from the compressor by the condenser, passing the refrigerant through the receiver drier and the expansion valve, and then evaporating the refrigerant in the evaporator in a cooling mode.

Recently, in accordance with a continuously increased interest in energy efficiency and environmental pollution, the development of an environmentally-friendly vehicle capable of substantially substituting for an internal combustion engine vehicle is desired. Environmentally-friendly vehicles are classified into electric vehicles driven using a fuel cell or electricity as a power source and hybrid vehicles driven using an engine and a battery.

Among these environmentally-friendly vehicles, a separate heater is not used unlike an air conditioner of a general vehicle. An air conditioner used in the environmentally-friendly vehicles is generally called a heat pump system.

The electric vehicles driven by the power source of the fuel cell generates driving force by converting chemical reaction energy between oxygen and hydrogen into electrical energy. In this process, heat energy is generated by a chemical reaction in a fuel cell. Therefore, it is desired to secure performance of the fuel cell by effectively removing the generated heat.

In addition, the hybrid vehicle generates driving force by driving a motor using electricity supplied from the fuel cell described above or an electrical battery, together with an engine operated by a fossil fuel. Therefore, heat generated from the fuel cell or the battery and the motor should be effectively removed in order to secure performance of the motor.

Therefore, in the hybrid vehicle or the electric vehicle according to the related art, a cooling means, a heat pump system, and a battery cooling system, respectively, should be configured as separate closed circuits so as to prevent heat generation of the motor, an electric component, and the battery including a fuel cell.

Therefore, the size and weight of a cooling module disposed at the front of the vehicle are increased. In addition, a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connection pipes are employed, and thus noise and vibration due to frequent opening and closing operations of the valves may introduced into the vehicle interior, thereby deteriorating the ride comfort.

In addition, since a separate heat-exchanger should be employed in order to recollect the waste heat from various heat sources in the heating mode of the vehicle, there is also the disadvantage of increasing the manufacturing cost.

The above information disclosed in this Background section is provided only to enhance understanding of the background of the present disclosure, and therefore it may contain information that does not form the prior art that is already known to a person of ordinary skill in the art.

### SUMMARY

The present disclosure provides a heat pump system for a vehicle configured to selectively exchange heat between the coolant and the thermal energy generated from the refrigerant at the time of condensation and evaporation of the refrigerant. The heat pump system may heat the vehicle interior using the heat-exchanged high-temperature coolant.

The present disclosure provides a heat pump system for a vehicle configured to improve the heating efficiency of the vehicle by selectively using the ambient air heat, the waste heat of electrical components, and the waste heat of the battery module, at the time of heating the vehicle interior, such that the heat pump system increases the overall travel distance of the vehicle by efficiently adjusting the temperature of a battery module for an optimal performance of the battery module.

In one embodiment of the present disclosure, a heat pump system for a vehicle may include a valve module including a plurality of ports through which a coolant may be introduced or discharged; and a first line having a first end and a second end connected to the valve module to flow the coolant. The first line further includes a radiator and an electrical component. The heat pump system further includes a second line having a first end and a second end connected to the valve module to flow the coolant. The second line further includes a battery module and a chiller. The heat pump system also includes a third line having a first end and a second end connected to the valve module to flow the coolant. The third line further includes a condenser and a heating core. In particular, the valve module is configured to to selectively connect at least two lines among the first line, the second line and the third line according to at least one mode in which the temperature of a vehicle interior of the vehicle and the temperature of the battery module are adjusted. The valve module is configured to control a flow of the coolant.

The at least one mode may include: a first mode for cooling the electrical component and the battery module by using the coolant cooled at the radiator; and a second mode for cooling the vehicle interior, the electrical component and the battery module using the coolant cooled at the radiator. The at least one mode may further include a third mode in which the vehicle interior and the electrical component are cooled using the coolant cooled by the radiator and the battery module is cooled using the coolant cooled by the chiller; and a fourth mode for heating the vehicle interior and the battery module while recollecting an ambient air heat and a waste heat of the electrical component. The at least one mode may further include a fifth mode for heating the vehicle interior by recollecting the ambient air heat, the waste heat of the electrical component, and a waste heat of the battery module. The at least one mode may also include a sixth mode for heating the vehicle interior by an electric heater and recollecting a residual heat of the coolant while heating the battery module.

In the first mode, the first line may be connected to the second line through an operation of the valve module such that the coolant cooled at the radiator may be introduced into the electrical component and the battery module, the third line may be closed by the operation of the valve module, and the coolant cooled at the radiator may pass through the battery module and then may be introduced into the electrical component.

In the second mode, the first line, the second line, and the third line may be interconnected by an operation of the valve module such that the coolant cooled at the radiator may be introduced into the electrical component, the battery module, and the condenser. In particular, the coolant cooled by the radiator may primarily pass through the battery module, then secondarily pass through the condenser and may be finally introduced into the electrical component.

In the third mode, the first line may be connected to the third line by an operation of the valve module such that the coolant cooled at the radiator may be introduced into the electrical component and the condenser, the second line may form an independent closed circuit through which the coolant circulates by the operation of the valve module such that the coolant cooled at the chiller may be supplied to the battery module, and the coolant cooled at the radiator may pass through the condenser and then may be introduced into the electrical component.

In the fourth mode, the first line may be connected to the third line by an operation of the valve module such that the coolant having passed through the radiator and the electrical component may be introduced into the condenser, the third line may be connected to the second line by the operation of the valve module such that the coolant having passed through the condenser may be introduced into the battery module and the chiller, the coolant whose temperature is increased while passing through the condenser may be introduced into the heating core along the third line, and the coolant having passed through the heating core may be introduced into the battery module.

In the fifth mode, the first line may be connected to the second line by an operation of the valve module such that the coolant having passed through the radiator, the electrical component, and the battery module may be introduced into the chiller, the third line may form an independent closed circuit by an operation of the valve module such that the coolant may sequentially pass through the condenser and the heating core along the third line, the coolant whose temperature is increased while passing through the condenser may be introduced into the heating core along the third line, and the chiller may be configured to recollect the ambient air heat, the waste heat of the electrical component, and the waste heat of the battery module while exchanging heat between the coolant having passed through the radiator, the electrical component, the battery module an a refrigerant.

In the sixth mode, the first line may be closed by an operation of the valve module, the third line may be connected to the second line by the operation of the valve module such that the coolant having passed through the condenser and the electric heater may sequentially pass through the battery module and the chiller, the electric heater may be operated, the coolant whose temperature is increased by the electric heater may be introduced into the heating core along the third line, the battery module may increase its temperature by the coolant whose temperature is increased while passing through the electric heater, and the chiller recollects a residual heat remaining in the coolant having passed through the battery module.

The valve module may include a first port connected the first end of the first line, a second port connected the second end of the first line, a third port connected the first end of the second line, a fourth port connected the second end of the second line, a fifth port connected the first end of the third line, and a sixth port connected the second end of the third line.

A heat pump system may further include a first water pump disposed on the second line, and a second water pump disposed on the third line.

An electric heater may be further disposed on the third line such that the coolant may sequentially pass through the condenser and the electric heater.

The electric heater may be disposed on the third line separately from the condenser or integrally formed with the condenser.

An autonomous driving controller may be disposed on the second line.

As described above, according to a heat pump system for a vehicle according to an embodiment, by selectively exchanging heat between the coolant and the thermal energy generated from the refrigerant at the time of condensation and evaporation of the refrigerant, and performing heating of the vehicle interior by using the heat-exchanged high-temperature coolant, the entire system may be streamlined and the layout of connection pipes through which the refrigerant circulates may be streamlined.

In addition, according to the present disclosure, by selectively using the ambient air heat, the waste heat of the electrical component, and the waste heat of the battery module, at the time of heating the vehicle interior, the heating efficiency may be improved, and the overall travel distance of the vehicle may be increased through an efficient temperature adjustment of the battery module for an optimal performance of the battery module.

In addition, according to the present disclosure, the temperature of electrical components and the battery module may be efficiently adjusted through the valve control, and accordingly, the overall marketability of the vehicle may be improved.

In addition, according to the present disclosure, due to streamlining of the entire system, it is possible to reduce the overall manufacturing cost and weight, and to improve space utilization by minimizing the number of components.

### BRIEF DESCRIPTION OF THE DRAWINGS

FIG. 1 is a block diagram of a heat pump system for a vehicle according to an embodiment.

FIG. 2 is an operation diagram according to a first mode in a heat pump system for a vehicle according to an embodiment.

FIG. 3 is an operation diagram according to a second mode in a heat pump system for a vehicle according to an embodiment.

FIG. 4 is an operation diagram according to a third mode in a heat pump system for a vehicle according to an embodiment.

FIG. 5 is an operation diagram according to a fourth mode in a heat pump system for a vehicle according to an embodiment.

FIG. 6 is an operation diagram according to a fifth mode in a heat pump system for a vehicle according to an embodiment.

FIG. 7 is an operation diagram according to a sixth mode in a heat pump system for a vehicle according to an embodiment.

### DETAILED DESCRIPTION

Some embodiments are hereinafter described in detail with reference to the accompanying drawings.

Embodiments disclosed in the present specification and the configuration depicted in the drawings are only example embodiments of the present disclosure, and do not cover the entire scope of the present disclosure. Therefore, it should be understood that there may be various equivalents and variations at the time of the application of this specification.

In order to clarify the present disclosure, parts that are not related to the description have been omitted, and the same elements or equivalents are referred to with the same reference numerals throughout the present disclosure.

Also, the size and thickness of each element are arbitrarily shown in the drawings, but the present disclosure is not necessarily limited thereto, and in the drawings, the thickness of layers, films, panels, regions, etc., are exaggerated for clarity.

In addition, unless explicitly described to the contrary, the word “comprise” and variations such as “comprises” or “comprising”, should be understood to imply the inclusion of stated elements but not the exclusion of any other elements. The same is true for terms such as “have,” “include,” and the like.

Furthermore, each of terms, such as “ . . . unit”, “ . . . means”, “ . . . portions”, “ . . . part”, and “ . . . member” described in the specification, mean a unit of a comprehensive element that performs at least one function or operation.

When a component, device, element, or the like of the present disclosure is described as having a purpose or performing an operation, function, or the like, the component, device, or element should be considered herein as being “configured to” meet that purpose or to perform that operation or function.

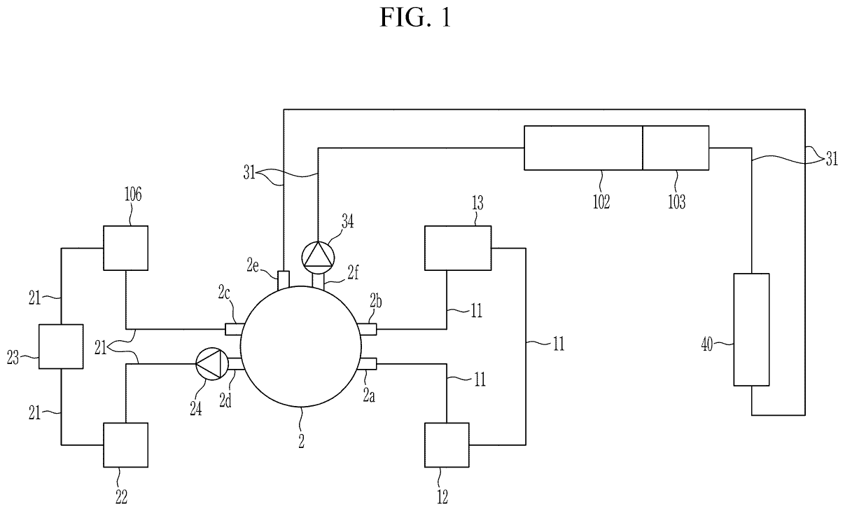

FIG. 1 is a block diagram of a heat pump system for a vehicle according to an embodiment.

A heat pump system for a vehicle according to an embodiment may selectively exchange heat between a coolant and a thermal energy generated from the refrigerant at the time of condensing and evaporating a refrigerant, and may perform heating of a vehicle interior by using a high-temperature coolant.

In addition, the heat pump system may improve heating efficiency of the vehicle by selectively using an ambient air heat, a waste heat of an electrical component 13, and a waste heat of a battery module 22 to heat the vehicle interior. The heat pump system may efficiently adjust the temperature of the battery module 22 for an optimal performance of the battery module 22, thereby increasing the overall travel distance of the vehicle.

Such a heat pump system may be applied to a hybrid vehicle or an electric vehicle.

Referring to FIG. 1, the heat pump system may include a valve module 2, a first line 11, a second line 21, and a third line 31.

In one embodiment, the valve module 2 may include a plurality of ports through which the coolant is introduced or discharged, and may control a flowing movement of the introduced coolant.

The first line 11 may have a first end and a second end connected to the valve module 2, and the coolant may flow through the first line 11. A radiator 12 and the electrical component 13 may be provided on the first line 11.

The radiator 12 may be disposed in the front of the vehicle, and a cooling fan may be provided at a downstream side of the radiator 12. Accordingly, the radiator 12 may cool the coolant through an operation of the cooling fan and heat-exchange with the ambient air.

Accordingly, the coolant cooled at the radiator 12 may circulate along the first line 11 to flow to the valve module 2.

In one embodiment, the electrical component 13 may include an electric power control unit (EPCU) including at least one of a motor, an on-board charger (OBC), or the like.

The power control apparatus may generate heat while the vehicle is driving, and the charger may generate heat when charging the battery module 22.

In other words, at the time of heating the vehicle interior, when the waste heat of the electrical component 13 is to be recollected, the heat generated from the power control apparatus may be recollected, and the heat generated from the charger may be recollect at the time of charging the battery module 22.

In one embodiment, the second line 21 may have a first end and a second end connected to the valve module 2, and the coolant may flow through the second line 21. The battery module 22 and a chiller 106 may be provided on the second line 21. In addition, an autonomous driving controller 23 and a first water pump 24 may be further provided on the second line 21.

Here, the autonomous driving controller 23 may be disposed on the second line 21 between the battery module 22 and the chiller 106. In addition, the first water pump 24 may be an electric water pump.

The selectively expanded refrigerant may be introduced into the chiller 106. For cooling the battery module 22 and the autonomous driving controller 23, or for heating the vehicle interior, the chiller 106 may operate in order to recollect heat from the coolant whose temperature is increased by at least one of the ambient air heat, the waste heat of the electrical component 13, or the waste heat of the battery module 22.

In addition, the third line 31 may have a first end and a second end connected to the valve module 2, and the coolant may flow through the third line 31. A second water pump 34, a condenser 102, and a heating core 40 may be provided on the third line 31.

Here, the second water pump 34 may be an electric water pump.

In one embodiment, the condenser 102 may be connected to a compressor (not shown) through the refrigerant line. The condenser 102 may condense the refrigerant through heat exchange between the refrigerant and the coolant that circulates the third line 31.

In other words, the condenser 102 may condense the introduced refrigerant by exchanging heat with the coolant and may increase the temperature of the coolant by supplying the thermal energy generated while condensing the refrigerant to the coolant.

The condenser 102 may be a water-cooled heat-exchanger into which the coolant is introduced.

Here, an electric heater 103 may be further provided on the third line 31. The electric heater 103 may be provided on the third line 31 separately from the condenser 102 or may be integrally formed with the condenser 102.

The electric heater 103 may selectively heat the coolant introduced through the third line 31, and thereby increase the temperature of the coolant.

Accordingly, the third line 31 may be connected to the condenser 102 and the electric heater 103 such that the coolant may sequentially pass through the condenser 102 and the electric heater 103.

Although not shown in the drawings, for cooling the vehicle interior, the heat pump system may further include an evaporator for cooling the ambient air. The expanded refrigerant may be selectively supplied to the evaporator.

In other words, when cooling of the vehicle interior is required, or when dehumidification is required while heating the vehicle interior, the expanded refrigerant may be introduced into the evaporator.

Meanwhile, the refrigerant may be selectively introduced into the condenser 102, the evaporator, and the chiller 106, as described above.

Accordingly, the condenser 102 and the chiller 106 may selectively exchange heat between the thermal energy generated by condensation and evaporation of the refrigerant and the coolant flowing through the third line 31 and the second line 21. In more detail, the high-temperature coolant having heat-exchanged at the condenser 102 may be introduced into the heating core 40 provided on the third line 31 by an operation of the valve module 2 and the second water pump 34 depending on the selected mode of the vehicle.

In one embodiment, the heating core 40 and the evaporator may be provided inside a heating, ventilation, and air conditioning (HVAC) module (not shown).

In other words, the ambient air introduced into the vehicle interior may be converted into the high-temperature state or the low-temperature state while exchanging heat with the high-temperature coolant introduced into the heating core 40 or the refrigerant introduced into the evaporator by an operation of a blower-fan (not shown).

The ambient air of high temperature or low temperature may be introduced into the vehicle interior, thereby cooling or heating the vehicle interior.

In one embodiment, the valve module 2 may be a 6-way valve having six ports through which the coolant is introduced or discharged. The valve module 2 is described below in more detail.

The valve module 2 may include a first port 2a, a second port 2b, a third port 2c, and a fourth port 2d, a fifth port 2e, and a sixth port 2f.

In one embodiment, a first end of the first line 11 may be connected to the first port 2a of the valve module 2. A second end of the first line 11 may be connected to the second port 2b of the valve module 2.

In another embodiment, a first end of the second line 21 may be connected to the third port 2c of the valve module 2. A second end of the second line 21 may be connected to the fourth port 2d of the valve module 2.

In addition, a first end of the third line 31 may be connected to the fifth port 2e of the valve module 2. A second end of the third line 31 may be connected to the sixth port 2f of the valve module 2.

Although the valve module 2 is a 6-way valve forming six ports through which the coolant is introduced or discharged, the present disclosure is not limited thereto, for example, the valve module 2 may include more ports such that a separate component circulating the coolant may be connected.

The valve module 2 may operate to selectively interconnect the first line, the second line and the third line (11, 21, and 31) depending on at least one mode in which the temperature of the vehicle interior and the temperature of the battery module 22 are adjusted. The valve module 2 controls a flow of the coolant. In other words, the valve module 2 may selectively interconnect at least two lines among the first line, the second line and the third line (11, 21, and 31) to control the flow of the coolant based on the at least one mode.

The at least one mode may include a first mode to a sixth mode.

In the first mode, the electrical component 13 and the battery module 22 may be cooled by using the coolant cooled at the radiator 12.

In the second mode, the vehicle interior may be cooled, and the electrical component 13 and the battery module 22 may be cooled by using the coolant cooled at the radiator 12.

In the third mode, the vehicle interior may be cooled, the electrical component 13 may be cooled by using the coolant cooled at the radiator 12, and the battery module 22 may be cooled by using the coolant cooled at the chiller 106.

In the fourth mode, the vehicle interior may be heated, and the battery module 22 may be heated while recollecting the ambient air heat and the waste heat of the electrical component 13.

In the fifth mode, the vehicle interior may be heated, and the ambient air heat, the waste heat of the electrical component 13, and the waste heat of the battery module 22 may be recollected.

In addition, in the sixth mode, the vehicle interior may be heated by using the electric heater 103, and a residual heat of the coolant may be recollected while heating the battery module 22.

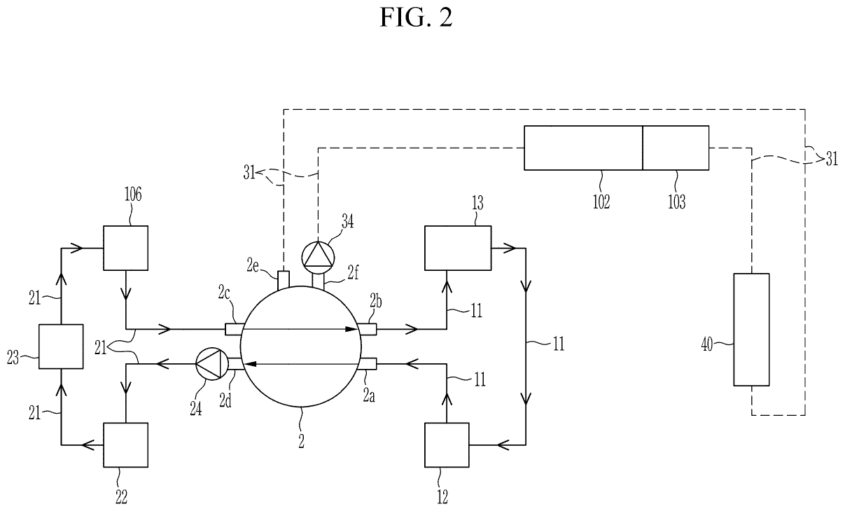

Hereinafter, an operation and action for each mode of a heat pump system for a vehicle according to an embodiment configured as described above is described in detail with reference to FIGS. 2-7.

In a heat pump system for a vehicle according to an embodiment, the operation according to the first mode for cooling the electrical component 13 and the battery module 22 by using the coolant cooled at the radiator 12 is described with reference to FIG. 2.

FIG. 2 is an operation diagram according to the first mode in a heat pump system for a vehicle according to an embodiment.

Referring to FIG. 2, the refrigerant may not be supplied to the condenser 102, the evaporator, and the chiller 106.

In addition, the first line 11 may be connected to the second line 21 by an operation of the valve module 2 such that the coolant cooled at the radiator 12 may be introduced into the electrical component 13 and the battery module 22.

Simultaneously, the third line 31 may be close by the operation of the valve module 2.

Accordingly, the coolant cooled at the radiator 12 may be introduced into the first port 2a of the valve module 2 along the first line 11 by an operation of the first water pump 24.

The coolant introduced into the first port 2a of the valve module 2 may be discharged to the second line 21 connected to the fourth port 2d of the valve module 2 by the operation of the valve module 2.

The coolant discharged to the second line 21 may sequentially pass through the battery module 22, the autonomous driving controller 23, and the chiller 106. Thereafter, the coolant may be introduced into the third port 2c of the valve module 2.

The coolant introduced into the third port 2c of the valve module 2 may be discharged to the first line 11 connected to the second port 2b of the valve module 2 by the operation of the valve module 2.

The coolant discharged to the first line 11 may pass through the electrical component 13 along the first line 11 and then may be introduced into the radiator 12.

In other words, in the first mode, the first line 11 and the second line 21 may form one closed circuit through which the coolant circulates by the operation of the valve module 2.

In such a state, the coolant may circulate along the first line 11 and the second line 21 interconnected by the operation of the first water pump 24.

The coolant cooled by the radiator 12 may circulate along the first line 11 and the second line 21 while repeatedly performing the above-described operation.

In more detail, the coolant cooled at the radiator 12 may first pass through the battery module 22 along the second line 21, and then may pass through the autonomous driving controller 23. Thereafter, the coolant may be introduced from the second line 21 to the electrical component 13 along the first line 11 connected through the valve module 2.

Accordingly, the electrical component 13, the battery module 22, and the autonomous driving controller 23 may be efficiently cooled by the coolant cooled by the radiator 12.

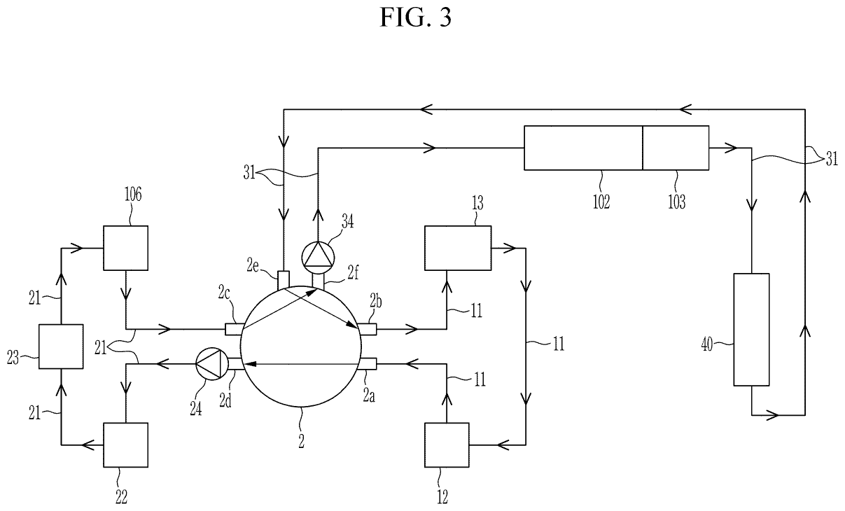

In a heat pump system for a vehicle according to an embodiment, the operation according to the second mode for cooling the vehicle interior and cooling the electrical component 13 and the battery module 22 by using the coolant cooled by the radiator 12 is described with reference to FIG. 3.

FIG. 3 is an operation diagram according to the second mode in a heat pump system for a vehicle according to an embodiment.

Referring to FIG. 3, the refrigerant may circulate through the condenser 102 and the evaporator. At this time, the refrigerant may not be supplied to the chiller 106, and the expanded refrigerant may be supplied to the evaporator.

In addition, the first line 11, the second line 21, and the third line 31 may be interconnected by the operation of the valve module 2 such that the coolant cooled by the radiator 12 may be introduced into the electrical component 13, the battery module 22, and the condenser 102.

Accordingly, the coolant cooled by the radiator 12 may be introduced into the first port 2a of the valve module 2 along the first line 11 by the operation of the first water pump 24.

The coolant introduced into the first port 2a of the valve module 2 may be discharged to the second line 21 connected to the fourth port 2d of the valve module 2 by the operation of the valve module 2.

The coolant discharged to the second line 21 may sequentially pass through the battery module 22, the autonomous driving controller 23, and the chiller 106. Thereafter, the coolant may be introduced into the third port 2c of the valve module 2.

The coolant introduced into the third port 2c of the valve module 2 may be discharged to the third line 31 connected to the sixth port 2f of the valve module 2 by the operation of the valve module 2 and the second water pump 34.

The coolant discharged to the third line 31 may sequentially pass through the condenser 102, the electric heater 103, and the heating core 40 along the third line 31. Here, the electric heater 103 may not be operated.

The coolant flowing through the third line 31 may be introduced into the fifth port 2e of the valve module 2.

The coolant introduced into the fifth port 2e of the valve module 2 may be supplied to the electrical component 13 along the first line 11 while being discharged to the second port 2b of the valve module 2 by the operation of the valve module 2.

In the second mode, the first line 11, the second line 21, and the third line 31 may form one closed circuit through which the coolant circulates by the operation of the valve module 2.

In such a state, the coolant may circulate along the first line 11, the second line 21, and the third line 31 that are interconnected by an operation of the first water pump 24 and the second water pump 34.

In other words, the coolant cooled at the radiator 12 may circulate along the first line 11, the second line 21, and the third line 31 while repeatedly performing the above-described operation.

Accordingly, the electrical component 13, the battery module 22, and the autonomous driving controller 23 may be efficiently cooled by the coolant cooled at the radiator 12.

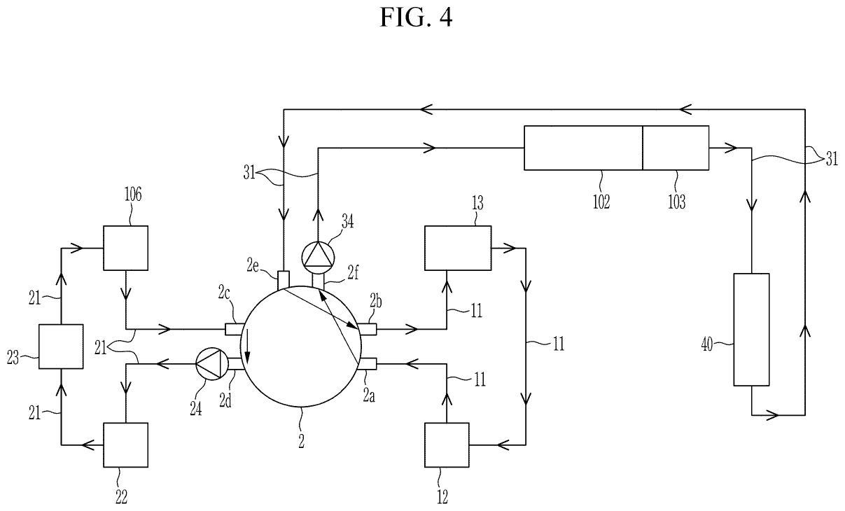

In a heat pump system for a vehicle according to an embodiment, the operation according to the third mode is described with reference to FIG. 4. In the third mode, the vehicle interior and the electrical component 13 are cooled using the coolant cooled at the radiator 12 and the battery module 22 is cooled using the coolant cooled at the chiller 106.

FIG. 4 is an operation diagram according to the third mode in a heat pump system for a vehicle according to an embodiment.

Referring to FIG. 4, the refrigerant may circulate through the condenser 102, the evaporator, and the chiller 106. At this time, the expanded refrigerant may be each supplied to the evaporator and the chiller 106.

In addition, the first line 11 may be connected to the third line 31 by the operation of the valve module 2 such that the coolant cooled at the radiator 12 may be introduced into the electrical component 13 and the condenser 102.

Accordingly, the coolant cooled at the radiator 12 may be introduced into the first port 2a of the valve module 2 along the first line 11 by an operation of the second water pump 34.

The coolant introduced into the first port 2a of the valve module 2 may be discharged to the third line 31 connected to the sixth port 2f of the valve module 2 by the operation of the valve module 2.

The coolant discharged to the third line 31 may sequentially pass through the condenser 102 and the electric heater 103, and then pass through the heating core 40. Here, the condenser 102 may condense the refrigerant by using the coolant flowing along the third line 31. At this time, the electric heater 103 is not operated.

Then, the coolant having passed through the heating core 40 may be introduced into the fifth port 2e of the valve module 2 along the third line 31.

The coolant introduced into the fifth port 2e of the valve module 2 may be discharged to the second port 2b of the valve module 2 and supplied to the electrical component 13 along the first line 11.

Accordingly, the electrical component 13 may be efficiently cooled by the coolant cooled at the radiator 12.

In other words, in the third mode, the first line 11 and the third line 31 may form one closed circuit through which the coolant circulates by the operation of the valve module 2.

In such a state, the coolant may circulate along the first line 11 and the third line 31 interconnected by the operation of the second water pump 34.

Meanwhile, the second line 21 may form an independent closed circuit through which the coolant circulates by the operation of the valve module 2 such that the coolant cooled through heat-exchange with the refrigerant while passing through the chiller 106 may be supplied to the battery module 22 and the autonomous driving controller 23.

In other words, the coolant introduced from the chiller 106 into the third port 2c of the valve module 2 along the second line 21 may be discharged to the second line 21 connected to the fourth port 2d of the valve module 2 by the operation of the valve module 2.

The coolant discharged to the second line 21 may pass through the battery module 22 and the autonomous driving controller 23 and then may be introduced back into the chiller 106. The coolant having passed through the chiller 106 may be introduced into the third port 2c of the valve module 2 along the second line 21.

Then, the coolant introduced into the third port 2c of the valve module 2 may be discharged to the second line 21 connected to the fourth port 2d of the valve module 2 by the operation of the valve module 2.

In other words, in the third mode, the second line 21 may form another closed circuit through which the coolant circulates by the operation of the valve module 2.

In such a state, the coolant may circulate along the second line 21 by the operation of the first water pump 24.

At this time, the chiller 106 may cool the coolant by exchanging heat between the coolant introduced through the second line 21 and the refrigerant.

Therefore, the coolant cooled at the chiller 106 may efficiently cool the battery module 22 and the autonomous driving controller 23 while circulating along the second line 21.

In addition, the evaporator may cool the ambient air through heat-exchange with the supplied refrigerant, and may evaporate the refrigerant.

In one embodiment, an opening/closing door (not shown) may be disposed between the evaporator and the heating core 40. The opening/closing door may close a side toward the heating core 40 such that the ambient air cooled while passing through the evaporator may be directly introduced into the vehicle.

In such a state, the ambient air introduced into the vehicle interior may be cooled while being heat-exchanged with a low-temperature refrigerant supplied to the evaporator by the operation of the blower-fan (not shown). Thereafter, the cooled ambient air may be directly introduced into the vehicle interior, thereby efficiently cooling the vehicle interior.

In addition, when dehumidification is required while cooling the vehicle interior, opening/closing door (not shown) may open a portion passing through the heating core 40 such that the ambient air cooled while passing through the evaporator may pass through the heating core 40.

Accordingly, the ambient air introduced into the vehicle interior may be cooled while being heat-exchanged with the low-temperature refrigerant supplied to the evaporator by the operation of the blower-fan (not shown). Thereafter, the cooled ambient air may be dehumidified while passing through the heating core 40 and introduced into the vehicle interior, thereby smoothly cooling and dehumidifying the vehicle interior.

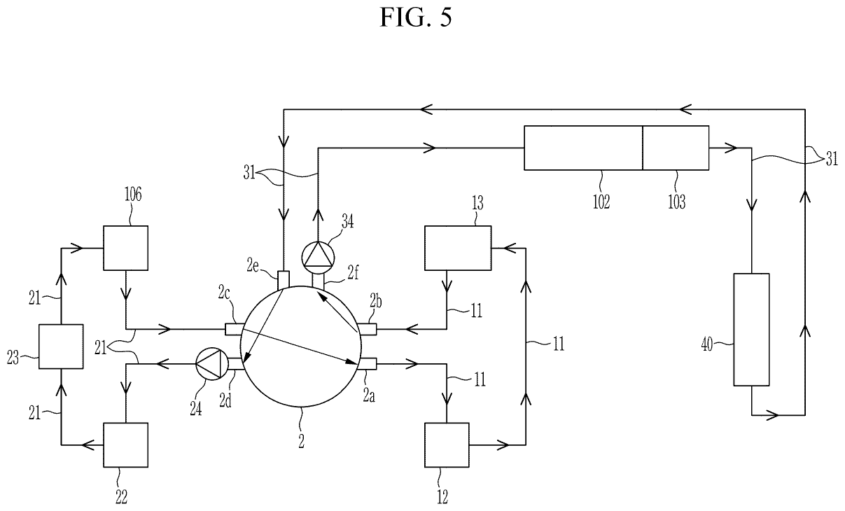

In a heat pump system for a vehicle according to an embodiment, the operation according to the fourth mode for heating the vehicle interior and the battery module 22 while recollecting the ambient air heat and the waste heat of the electrical component 13 is described with reference to FIG. 5.

FIG. 5 is an operation diagram according to the fourth mode in a heat pump system for a vehicle according to an embodiment.

Referring to FIG. 5, the refrigerant may circulate through the condenser 102 and the chiller 106. At this time, the expanded refrigerant may be supplied to the chiller 106.

In addition, the first line 11 may be connected to the third line 31 by the operation of the valve module 2 such that the coolant having passed through the radiator 12 and the electrical component 13 may be introduced into the condenser 102.

Simultaneously, the third line 31 may be connected to the second line 21 by the operation of the valve module 2 such that the coolant whose temperature is increased while passing through the condenser 102 may be introduced into the battery module 22 and the chiller 106.

Accordingly, the coolant may recollect the ambient air heat through heat-exchange with the ambient air while passing through the radiator 12 and may absorb the waste heat from the electrical component 13 to increase its temperature.

The coolant, whose temperature is increased, may be introduced into the second port 2b of the valve module 2 along the first line 11 by the operation of the second water pump 34.

The coolant introduced into the second port 2b of the valve module 2 may be discharged to the third line 31 connected to the sixth port 2f of the valve module 2 by the operation of the valve module 2.

The coolant discharged to the third line 31 may sequentially pass through the condenser 102 and the electric heater 103. Here, the condenser 102 may condense the refrigerant by using the coolant flowing along the third line 31.

At this time, the temperature of the coolant may be increased while condensing the refrigerant at the condenser 102. The coolant, whose temperature is increased while passing through the condenser 102, may be introduced into the heating core 40 along the third line 31.

In such a state, the ambient air introduced into the vehicle interior may be converted into the high-temperature state while being heat-exchanged with the high-temperature coolant supplied to the heating core 40 by the operation of the blower-fan (not shown). Thereafter, the ambient air in the high-temperature state may be introduced into the vehicle interior, thereby heating the vehicle interior.

Meanwhile, the coolant having passed through the heating core 40 may be introduced into the fifth port 2e of the valve module 2 along the third line 31.

The coolant introduced into the fifth port 2e of the valve module 2 may be discharged to the second line 21 connected to the fourth port 2d of the valve module 2 by an operation of the valve module 2 and the first water pump 24.

The coolant discharged to the second line 21 may increase the temperature of the battery module 22 while passing through the battery module 22. Through such an operation, the battery module 22 may efficiently increase its temperature as the coolant, whose temperature is increased, is supplied.

The coolant having passed through the battery module 22 and the autonomous driving controller 23 by the operation of the first water pump 24 may be introduced into the chiller 106 along the second line 21.

The coolant whose temperature is increased by recollecting the ambient air heat at the radiator 12 and absorbing the waste heat from the electrical component 13 may increase the temperature of the refrigerant supplied to the chiller 106. In other words, the chiller 106 may be used to increase the temperature of the refrigerant by recollecting the ambient air heat and the waste heat of the electrical component 13 through exchanging heat between the coolant and the refrigerant.

Then, the coolant having passed through the chiller 106 may be introduced into the third port 2c of the valve module 2 along the second line 21.

The coolant introduced into the third port 2c of the valve module 2 may be discharged to the first line 11 connected to the first port 2a of the valve module 2 by the operation of the valve module 2.

The coolant discharged to the first line 11 may sequentially pass through the radiator 12 and the electrical component 13, and then flow back into the valve module 2, thereby repeatedly performing the above-described processes.

In the fourth mode, the first line 11, the second line 21, and the third line 31 may form one closed circuit through which the coolant circulates by the operation of the valve module 2.

In such a state, the coolant may circulate along the first line 11, the third line 31, and the second line 21 that are interconnected by the operation of the first water pump 24 and the second water pump 34.

According to a heat pump system according to the present embodiment, the vehicle interior is heated by absorbing the ambient air heat and the waste heat of the electrical component 13 by the chiller 106 and using it to increase the temperature of the refrigerant, such that the power consumption of the compressor may be reduced and the heating efficiency may be improved.

In addition, when heating of the battery module 22 is required, the heat pump system may supply the coolant, whose temperature is increased while passing through the condenser 102, to the battery module 22, thereby efficiently increasing the temperature of the battery module 22.

When dehumidification is required while heating the vehicle interior, the expanded refrigerant may be supplied to the evaporator.

Simultaneously, an opening/closing door (not shown) may open a portion passing through the heating core 40 such that the ambient air cooled while passing through the evaporator may pass through the heating core 40.

Accordingly, the ambient air introduced into the vehicle interior may be dehumidified while being heat-exchanged with the low-temperature refrigerant supplied to the evaporator by the operation of the blower-fan (not shown). Thereafter, the dehumidified ambient air may be converted into the high-temperature state while passing through the heating core 40 and then introduced into the vehicle interior, thereby smoothly heating and dehumidifying the vehicle interior.

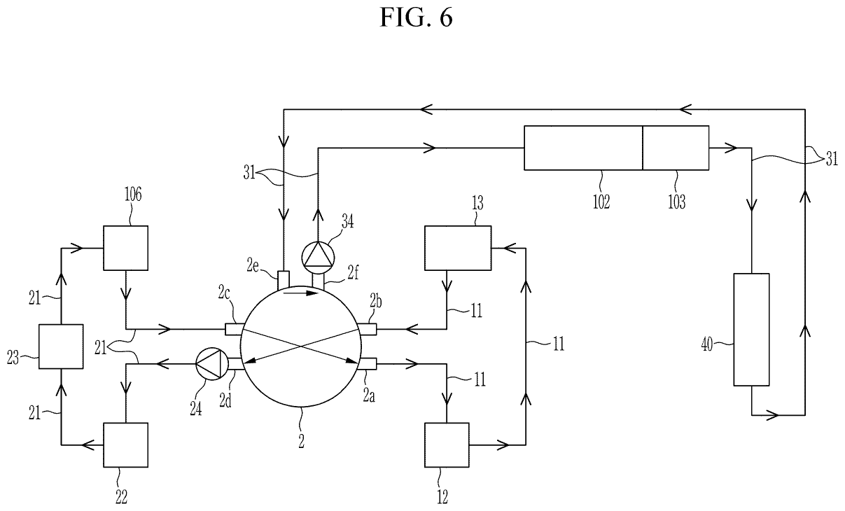

In a heat pump system for a vehicle according to an embodiment, the operation according to the fifth mode for heating the vehicle interior and recollecting the ambient air heat, the waste heat of the electrical component 13, and the waste heat of the battery module 22 is described with reference to FIG. 6.

FIG. 6 is an operation diagram according to the fifth mode in a heat pump system for a vehicle according to an embodiment.

Referring to FIG. 6, the refrigerant may circulate through the condenser 102 and the chiller 106. At this time, the expanded refrigerant may be supplied to the chiller 106.

In addition, the first line 11 may be connected to the second line 21 by the operation of the valve module 2 such that the coolant having passed through the radiator 12, the electrical component 13, and the battery module 22 may be introduced into the chiller 106.

Accordingly, the coolant may recollect the ambient air heat through heat-exchange with the ambient air while passing through the radiator 12 and may absorb the waste heat from the electrical component 13 to increase its temperature.

The coolant, whose temperature is increased, may be introduced into the second port 2b of the valve module 2 along the first line 11 by the operation of the first water pump 24.

The coolant introduced into the second port 2b of the valve module 2 may be discharged to the second line 21 connected to the fourth port 2d of the valve module 2 by the operation of the valve module 2.

The coolant discharged to the second line 21 may pass through the battery module 22 and the autonomous driving controller 23. Here, the coolant may absorb waste heat from the battery module 22 while passing through the battery module 22, thereby further increasing its temperature.

In such a state, the coolant may be supplied to the chiller 106 along the second line 21. Therefore, the ambient air heat recollected at the radiator 12, the waste heat generated at the electrical component 13, and the waste heat generated at the battery module 22 may increase the temperature of the refrigerant supplied to the chiller 106.

In other words, the chiller 106 may be used to increase the temperature of the refrigerant by recollecting the ambient air heat, the waste heat of the electrical component 13, the waste heat of the battery module 22 through exchanging heat between the coolant and the refrigerant.

Then, the coolant having passed through the chiller 106 may be introduced into the third port 2c of the valve module 2 along the second line 21.

Then, the coolant introduced into the third port 2c of the valve module 2 may be discharged to the first line 11 connected to the first port 2a of the valve module 2 by the operation of the valve module 2.

The coolant discharged to the first line 11 may sequentially pass through the radiator 12 and the electrical component 13, and then flow back into the valve module 2, thereby repeatedly performing the above-described processes.

In other words, in the fifth mode, the first line 11 and the second line 21 may form one closed circuit through which the coolant circulates by the operation of the valve module 2.

In such a state, the coolant may circulate along the first line 11 and the second line 21 interconnected by the operation of the first water pump 24.

Meanwhile, the third line 31 may form an independent closed circuit by the operation of the valve module 2 such that the coolant may sequentially pass through the condenser 102 and the heating core 40 along the third line 31.

The coolant introduced into the fifth port 2e of the valve module 2 through the third line 31 may be discharged to the sixth port 2f of the valve module 2 by an operation of the second water pump 34 and the valve module 2.

Then, the coolant circulating along the third line 31 may sequentially pass through the condenser 102 and the electric heater 103. Here, the condenser 102 may condense the refrigerant by using the coolant flowing along the third line 31.

At this time, the temperature of the coolant may be increased while condensing the refrigerant at the condenser 102. The coolant, whose temperature is increased while passing through the condenser 102, may be introduced into the heating core 40 along the third line 31.

In such a state, the ambient air introduced into the vehicle interior may be converted into the high-temperature state while being heat-exchanged with the high-temperature coolant supplied to the heating core 40 by the operation of the blower-fan (not shown).

Then, the ambient air in the high-temperature state may be introduced into the vehicle interior, thereby achieving heating of the vehicle interior.

According to a heat pump system according to the present embodiment, the vehicle interior is heated by the ambient air heat and the waste heat of the electrical component 13, and by absorbing the waste heat of the battery module 22 by the chiller 106 and using it to increase the temperature of the refrigerant, such that the power consumption of the compressor may be reduced and the heating efficiency may be improved.

Meanwhile, the coolant having passed through the heating core 40 may flow along the third line 31, and then flow into the fifth port 2e of the valve module 2, thereby repeatedly performing the above-described processes.

When dehumidification is required while heating the vehicle interior, the expanded refrigerant may be supplied to the evaporator.

Simultaneously, an opening/closing door (not shown) may open a portion passing through the heating core 40 such that the ambient air cooled while passing through the evaporator may pass through the heating core 40.

Accordingly, the ambient air introduced into the vehicle interior may be dehumidified while being heat-exchanged with the low-temperature refrigerant supplied to the evaporator by the operation of the blower-fan (not shown).

Then, the dehumidified ambient air may be converted into the high-temperature state while passing through the heating core 40 and then introduced into the vehicle interior, thereby smoothly heating and dehumidifying the vehicle interior.

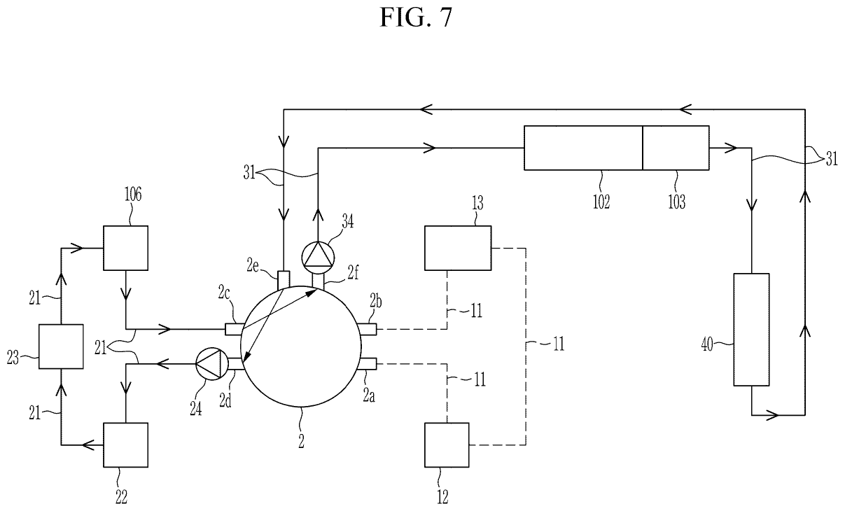

In addition, in a heat pump system for a vehicle according to an embodiment, the operation according to the sixth mode for heating the vehicle interior by using the electric heater 103 and recollecting the residual heat of the coolant while heating the battery module 22 is described with reference to FIG. 7.

FIG. 7 is an operation diagram according to the sixth mode in a heat pump system for a vehicle according to an embodiment.

Referring to FIG. 7, the refrigerant may circulate through the condenser 102 and the chiller 106. At this time, the refrigerant may not be supplied to the evaporator, and the expanded refrigerant may be supplied to the chiller 106.

Here, the first line 11 may be close by the operation of the valve module 2.

In such a state, the third line 31 may be connected to the second line 21 by the operation of the valve module 2 such that the coolant having passed through the condenser 102 and the electric heater 103 may sequentially pass through the battery module 22 and the chiller 106.

Here, the first water pump 24, the second water pump 34, and the electric heater 103 may be operated.

Accordingly, the coolant, whose temperature is increased while passing through the electric heater 103, may pass through the heating core 40 along the third line 31, and then may be introduced into the fifth port 2e of the valve module 2.

The coolant introduced into the fifth port 2e of the valve module 2 may be discharged to the second line 21 connected to the fourth port 2d of the valve module 2 by the operation of the valve module 2.

The coolant discharged to the second line 21 may increase the temperature of the battery module 22 while passing through the battery module 22.

Then, the coolant having passed through the battery module 22 and the autonomous driving controller 23 may be supplied to the chiller 106 along the second line 21. At this time, the chiller 106 may increase the temperature of the refrigerant by using the residual heat remaining in the coolant having passed through the battery module 22.

In other words, the chiller 106 may be used to increase the temperature of the refrigerant by recollecting the residual heat of the coolant through exchanging heat between the coolant and the refrigerant.

The refrigerant evaporated at the chiller 106 may be introduced into the compressor, and the refrigerant compressed at the compressor may be supplied to the condenser 102. Accordingly, the refrigerant supplied to the condenser 102 may increase the temperature of the coolant while being heat-exchanged with the coolant introduced through the third line 31.

Meanwhile, the coolant having passed through the chiller 106 may be introduced into the third port 2c of the valve module 2 along the second line 21.

The coolant introduced into the third port 2c of the valve module 2 may be discharged to the third line 31 connected to the sixth port 2f of the valve module 2 by the operation of the valve module 2.

The coolant discharged to the third line 31 may pass through the condenser 102 and the electric heater 103, and then may be introduced into the heating core 40 along the third line 31.

In addition, the coolant having passed through the heating core 40 may flow back into the valve module 2 along the third line 31, thereby repeatedly performing the above-described processes.

In other words, in the sixth mode, the second line 21 and the third line 31 may form one closed circuit through which the coolant circulates by the operation of the valve module 2.

In such a state, the coolant may circulate along the second line 21 and the third line 31 interconnected by an operation of the first and second water pumps 24 and 34.

Here, the electric heater 103 may heat the introduced coolant. At the same time, the condenser 102 may heat the introduced coolant, together with the electric heater 103.

In other words, in order to increase the temperature of the coolant, the electric heater 103 may perform a main role, and the condenser 102 may perform an auxiliary role. By such an operation, the temperature of the coolant may be increased.

The coolant, whose temperature is increased, may be introduced into the heating core 40 along the third line 31.

In such a state, the ambient air introduced into the vehicle interior may be converted into the high-temperature state while being heat-exchanged with the high-temperature coolant supplied to the heating core 40 by the operation of the blower-fan (not shown). Thereafter, the ambient air in the high-temperature state may be introduced into the vehicle interior, thereby achieving heating of the vehicle interior.

In addition, the heat pump system may supply the coolant, whose temperature is increased while passing through the electric heater 103, to the battery module 22 in order to heat the battery module 22, thereby efficiently increasing the temperature of the battery module 22.

In addition, the heat pump system may recollect the residual heat of the coolant having heated the battery module 22 by the chiller 106, and may minimize the usage of the electric heater 103 by using the condenser 102 as an auxiliary means for heating the coolant.

As described above, when a heat pump system for a vehicle according to an embodiment is applied, by selectively exchanging heat between the thermal energy generated from the refrigerant when condensing and evaporating the refrigerant and the coolant and by performing heating of the vehicle interior by using the heat-exchanged high-temperature coolant, the entire system may be streamlined and the layout of connection pipes through which the refrigerant circulates may be streamlined.

In addition, according to the present disclosure, for heating the vehicle interior, the heating efficiency of the vehicle may be improved by selectively using the ambient air heat, the waste heat of the electrical component 13, and the waste heat of the battery module 22, and the overall travel distance of the vehicle may be increased through efficient temperature adjustment of the battery module 22, such that the battery module 22 may exhibit optimal performance.

In addition, according to the present disclosure, the temperature of the electrical component 13 and the battery module 22 may be efficiently adjusted by controlling the valve module 2, and thereby the overall marketability of the vehicle may be improved.

In addition, according to the present disclosure, due to streamlining of the entire system, it is possible to reduce the overall manufacturing cost and weight, and improve space utilization by minimizing the number of components.

While the present disclosure has been described in connection with what is presently considered to be practical exemplary embodiments, it should be understood that the present disclosure is not limited to the disclosed embodiments. On the contrary, it is intended to cover various modifications and equivalent arrangements included within the spirit and scope of the appended claims.

### DESCRIPTION OF SYMBOLS

2: valve module
11: first line
12: radiator
13: electrical component
21: second line
22: battery module
23: autonomous driving controller
24: first water pump
31: third line
34: second water pump
40: heating core
102: condenser
103: electric heater
106: chiller

What is claimed is:

1. A heat pump system for a vehicle, comprising:
a valve module including a plurality of ports through which a coolant is introduced or discharged;
a first line having a first end and a second end connected to the valve module to flow the coolant and including a radiator and an electrical component;
a second line having a first end and a second end connected to the valve module to flow the coolant and including a battery module and a chiller; and
a third line having a first end and a second end connected to the valve module to flow the coolant and including a condenser and a heating core,
wherein the valve module is configured to selectively connect at least two lines among the first to the third lines to control a flow of the coolant based on at least one mode in which a temperature of a vehicle interior and the battery module of the vehicle is adjusted.

2. The heat pump system of claim 1, wherein the at least one mode comprises:
a first mode for cooling the electrical component and the battery module by using the coolant cooled at the radiator;
a second mode for cooling the vehicle interior, the electrical component and the battery module by using the coolant cooled sby the radiator;
a third mode in which the vehicle interior and the electrical component are cooled using the coolant cooled by the radiator and the battery module is cooled using the coolant cooled by the chiller;
a fourth mode for heating the vehicle interior and the battery module while recollecting an ambient air heat and a waste heat of the electrical component;
a fifth mode for heating the vehicle interior by recollecting the ambient air heat, the waste heat of the electrical component, and a waste heat of the battery module; and
a sixth mode for heating the vehicle interior by an electric heater and recollecting a residual heat of the coolant while heating the battery module.

3. The heat pump system of claim 2, wherein, in the first mode:
the first line is connected to the second line by the valve module such that the coolant cooled by the radiator is introduced into the electrical component and the battery module;
the third line is closed by the valve module; and
the coolant cooled by the radiator passes through the battery module and then is introduced into the electrical component.

4. The heat pump system of claim 2, wherein, in the second mode:
the first line, the second line, and the third line are interconnected by the valve module such that the coolant cooled by the radiator is introduced into the electrical component, the battery module, and the condenser; and
the coolant cooled by the radiator primarily passes through the battery module, then secondarily passes through the condenser, and is finally introduced into the electrical component.

5. The heat pump system of claim 2, wherein, in the third mode:
the first line is connected to the third line by the valve module such that the coolant cooled by the radiator passes through the condenser and then is introduced into the electrical components; and
the second line forms an independent closed circuit through which the coolant cooled by the chiller is supplied to the battery module.

6. The heat pump system of claim 2, wherein, in the fourth mode:
the first line is connected to the third line by the valve module such that the coolant having passed through the radiator and the electrical component is introduced into the condenser;
the third line is connected to the second line by the valve module such that the coolant having passed through the condenser is introduced into the battery module and the chiller;
the coolant, whose temperature is increased while passing through the condenser, is introduced into the heating core along the third line; and
the coolant having passed through the heating core is introduced into the battery module.

7. The heat pump system of claim 2, wherein, in the fifth mode:
the first line is connected to the second line by the valve module such that the coolant having passed through the radiator, the electrical component, and the battery module is introduced into the chiller;
the third line forms an independent closed circuit by the valve module such that the coolant sequentially passes through the condenser and the heating core along the third line;
the coolant, whose temperature is increased while passing through the condenser, is introduced into the heating core along the third line; and
the chiller is configured to recollect the ambient air heat, the waste heat of the electrical component, and the waste heat of the battery module, while exchanging heat between the coolant having passed through the radiator, the electrical component, the battery module and a refrigerant.

8. The heat pump system of claim 2, wherein, in the sixth mode:
the first line is closed by the valve module;
the third line is connected to the second line by the valve module such that the coolant having passed through the condenser and the electric heater sequentially passes through the battery module and the chiller;
the electric heater is operated;
the coolant, whose temperature is increased by the electric heater, is introduced into the heating core along the third line;
the battery module increases its temperature by the coolant whose temperature is increased while passing through the electric heater; and
the chiller recollects a residual heat remaining in the coolant having passed through the battery module.

9. The heat pump system of claim 1, wherein the valve module comprises:
a first port connected the first end of the first line;
a second port connected the second end of the first line;
a third port connected the first end of the second line;
a fourth port connected the second end of the second line;
a fifth port connected the first end of the third line; and
a sixth port connected the second end of the third line.

10. The heat pump system of claim 1, further comprising:
a first water pump disposed on the second line; and
a second water pump disposed on the third line.

11. The heat pump system of claim 1, wherein an electric heater is further disposed on the third line such that the coolant sequentially passes through the condenser and the electric heater.

12. The heat pump system of claim 11, wherein the electric heater is disposed on the third line separately from the condenser or integrally formed with the condenser.

13. The heat pump system of claim 1, wherein an autonomous driving controller is disposed on the second line.
